(19) United States
(12) Patent Application Publication
(10) Pub. No.: US 2020/0173594 A1
(43) Pub. Date: Jun. 4, 2020

(54) Oxygen Supply Tubing Connector with Reverse Directional Coupling

(71) Applicant: Thomas W. NAU, San Antonio, TX (US)

(72) Inventor: Thomas W. NAU, San Antonio, TX (US)

(21) Appl. No.: 16/205,209

(22) Filed: Nov. 29, 2018

(51) Int. Cl. F16L 47/04; F16L 13/14

(52) U.S. Cl. CPC F16L 47/04; F16L 13/147

(57) ABSTRACT

A connector for positioning and reorienting a length of flexible tubing between a gas supply source and a gas use device to prevent binding and/or constriction. The connector includes a “U” shaped body section of rigid tubing with an inlet and an outlet. A flexible and/or resilient inlet connector is removably positioned on the rigid tubing inlet, and a flexible and/or resilient outlet connector is removably positioned on the rigid tubing outlet. The outlet connector is preferably (and typically) incorporated into the construction of the length of flexible tubing. The inlet connector end of the device, which may be permanently fixed to or removable from the device, is in turn removably attached to the gas supply source. Alternate embodiments include fixed and swiveling connector couplings.

### BACKGROUND OF THE INVENTION

### 1. Field of the Invention

The present invention relates generally to medical and healthcare systems and devices. The present invention relates more specifically to tubing connectors associated with supplemental oxygen delivery systems and other supplemental breathing devices used in the healthcare field.

### 2. Description of the Related Art

Patients receiving supplemental oxygen are generally supplied with an oxygen tank, a regulator assembly and a nasal cannula. The regulator assembly is attached onto the top of the tank and secured. The industry standard design of regulators places the supply port (oxygen outlet) at the bottom of the regulator structure pointing downward. The female (inlet) end of the nasal cannula is attached to the supply port and the opposite (outlet) end is secured to the patient. Securing the tubing to the patient is accomplished by looping a split portion (from a “Y”) of the tubing around the patient's ears with a middle section of tubing between the loops over the ears having two exit ports that are aligned with each nostril of the patient.

As mentioned, the industry standard design of the regulator positions and orients the supply port pointing downward. This is preferred as it prevents small amounts of condensate in the tubing from draining into the port. When the patient is sitting or lying down, the oxygen tank is normally sitting at a lower position, i.e. the floor, a dolly, etc. Unfortunately, because the nasal cannula is typically made of soft plastic tubing, it will kink at the regulator port when subject to the sharp angle that results from the tubing being pulled upward by the user. This leads to the oxygen supply being dramatically reduced or terminated completely.

The present invention attaches to the current industry standard regulator port, changing the direction of the port from a downward orientation to an upward orientation (in the direction of the patient). The nasal cannula would then attach to the device of the present invention and therefore prevent the issue of kinked tubing. A preferred embodiment of the invention would be constructed of hard plastic molded in the configuration described in the following detailed description of the invention and as shown in the accompanying drawing figures.

### SUMMARY OF THE INVENTION

The present invention therefore provides a connector for positioning and reorienting a length of flexible tubing between a gas supply source and a gas use device to prevent binding and/or constriction. The connector includes a “U” shaped body section of rigid tubing with an inlet and an outlet. A flexible and/or resilient inlet connector is removably positioned on the rigid tubing inlet, and a flexible and/or resilient outlet connector is removably positioned on the rigid tubing outlet. The outlet connector is preferably (and typically) incorporated into the construction of the length of flexible tubing. The inlet connector end of the device, which may be permanently fixed to or removable from the device, is in turn removably attached to the gas supply source. Alternate embodiments include fixed and swiveling connector couplings.

### BRIEF DESCRIPTION OF THE DRAWINGS

FIG. 1 is a perspective view of the connector device of the present invention shown in use and attached to a typical medical oxygen supply system.

FIG. 2 is a partial cross-sectional view of a first preferred embodiment of the present invention shown attached to a length of nasal cannula tubing and the standard oxygen supply outlet port.

FIG. 3 is an elevational side view of the first preferred embodiment of the present invention shown separated from attachment to the system shown in FIG. 1.

FIG. 4 is a partial cross-sectional view of a second preferred embodiment of the present invention shown attached to a length of nasal cannula tubing and the standard oxygen supply outlet port.

FIG. 5 is an elevational side view of the second preferred embodiment of the present invention shown separated from attachment to the system shown in FIG. 1.

FIG. 6 is a partial cross-sectional view of a third preferred embodiment of the present invention shown attached to the standard oxygen supply outlet port.

FIG. 7 is an elevational side view of a fourth preferred embodiment of the present invention shown separated from attachment to the system shown in FIG. 1.

### DETAILED DESCRIPTION OF THE PREFERRED EMBODIMENTS

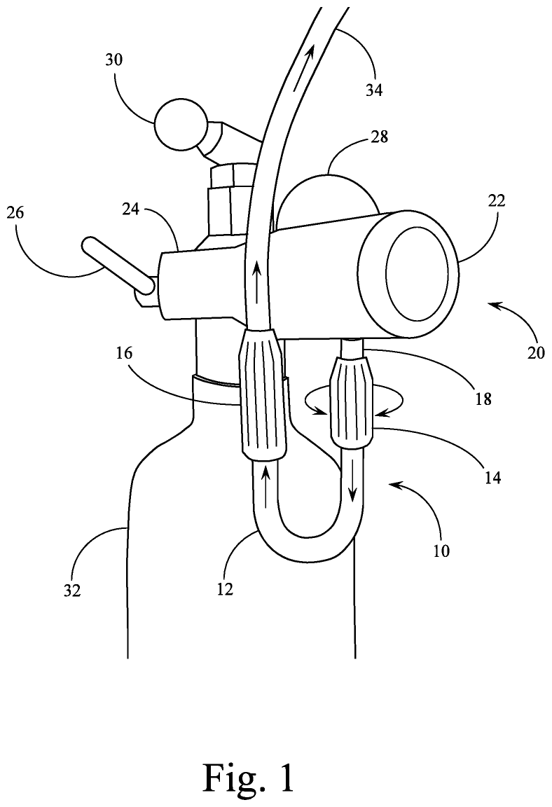

Reference is made first to FIG. 1 for a perspective assembly view of the connector of the present invention shown in use and attached to a typical medical oxygen supply system. The basis for the need of the present invention is the typical orientation of the oxygen outlet port on a standard supplemental oxygen or air supply system. FIG. 1 shows the typical arrangement of a pressurized oxygen cylinder 32 fitted with an oxygen regulator 20. The oxygen regulator 20 is attached to pressurized oxygen cylinder 32 by way of regulator yoke 24 secured with T-handle 26. Oxygen regulator 20 is generally constructed with flow selection knob 22, pressure gauge 28, and tank on/off valve 30. Once the regulator flow is set, oxygen flows out of pressurized oxygen cylinder 32 through oxygen regulator 20 and out through oxygen outlet 18.

Without the device of the present invention, nasal cannula tubing 34 would be secured to oxygen outlet 18 by way of nasal cannula tubing coupler 16. As is apparent from FIG. 1 the orientation of oxygen outlet 18 determines the orientation of nasal cannula tubing 34 directly connected to the individual using the supplemental oxygen supply. Without use of the present invention, the nasal cannula tubing extends from the oxygen supply system in a downward orientation even though the user is typically positioned above the supplemental oxygen reservoir. In practice, this reverse orientation results in bent, twisted, and kinked tubing leading to the nasal cannula. The present invention provides a solution to this problem by reorienting the oxygen outlet so as to effectively prevent kinking of the tubing and eliminating flow restrictions caused by the necessary abrupt change in direction of the tubing connection.

In FIG. 1, direction reversing connector 10 is shown attached to oxygen outlet 18 by way of oxygen outlet coupler 14. The rigid connector body 12 of direction reversing connector 10 effectively reorients the oxygen outlet 180 degrees. Nasal cannula tubing coupler 16 is connected to nasal cannula tubing 34 by way of removable attachment to direction reversing connector 10. The directional arrows shown on rigid connector body 12 in FIG. 1 demonstrate the direction of oxygen flow within the direction reversing connector. The circular arrow surrounding oxygen outlet coupler 14 indicate the structure of the connection to allow for swiveling of the connection during use. Some movement of the individual utilizing the nasal cannula tubing 34 is anticipated. With direction reversing connector 10 of the present invention providing sufficient rigidity to the reorientation of the tubing attachment and having sufficient flexibility in oxygen outlet coupler 14 any flow restrictions resulting from the from such movement.

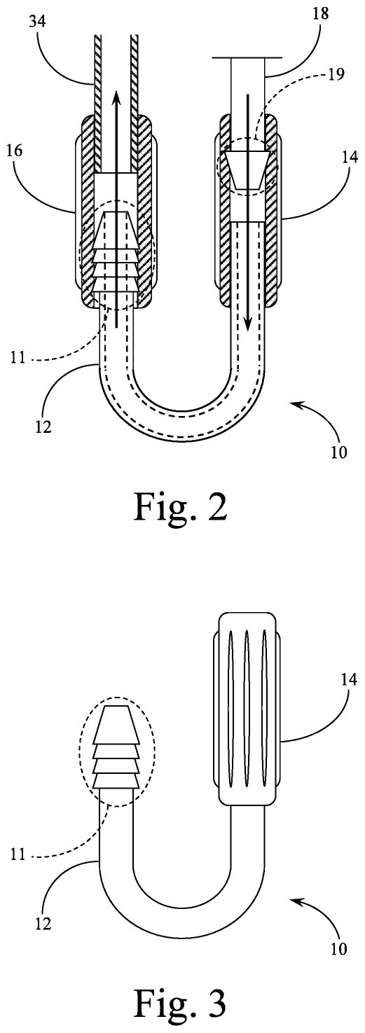

Various embodiments of the device of the present invention as shown in use in FIG. 1 are anticipated. FIGS. 2 & 3 disclose a first preferred embodiment of the invention constructed of a rigid component and a flexible coupler component. FIG. 2 is a partial cross-sectional view of the device of the present invention detailing the manner of attachment to a pressurized supplemental oxygen system. In FIG. 2, direction reversing connector 10 is shown attached to oxygen outlet 18 using oxygen outlet coupler 14. Oxygen outlet coupler 14 is secured onto oxygen outlet tip barb 19 in a press-fit manner with the resilient material of coupler 14 tight enough to removably secure connector 10 to oxygen outlet 18.

In this embodiment of FIGS. 2 & 3, rigid connector body 12 is permanently fixed to oxygen outlet coupler 14. Depending on the materials utilized in the construction of direction reversing connector 10, oxygen outlet coupler 14 may be molded to rigid connector body 12 or may be secured with an adhesive at the interface of the components. In any case, oxygen outlet coupler 14 is permanently fixed to rigid connector body 12 thereby allowing for the repeated attachment and removal of direction reversing connector 10 on to and off from oxygen outlet 18. As suggested in FIG. 1, the connection between oxygen outlet coupler 14 and oxygen outlet 18 using oxygen outlet tip barb 19, is sufficiently resilient and low-friction as to allow some swivel rotation of oxygen outlet coupler 14 around oxygen outlet tip barb 19 as may result from the movement of the user.

As seen in FIG. 2, rigid connector body 12 is configured from a section of U-shaped tubing, fitted as mentioned above with oxygen outlet coupler 14 on one end and constructed with connector tip barbs 11 on the opposite outlet end. As further indicated above, nasal cannula tubing 34 is typically provided with a permanently attached nasal cannula tubing coupler 16, generally designed to attach to oxygen outlet 18. The present invention provides not only a reorientation of this connection but an extension of the oxygen outlet to a more secure and yet more flexible location at the outlet end of rigid connector body 12. Nasal cannula tubing coupler 16 and oxygen outlet coupler 14 are similar in structure and material. Where oxygen outlet coupler 14 is permanently attached to the inlet end of rigid connector body 12, nasal cannula tubing coupler 16 is permanently attached to the inlet end of nasal cannula tubing 34. Couplers 14 & 16 are preferably made from a resilient or semi-resilient tubular section of polymer plastic or silicone rubber material, flexible enough to withstand repeated attachment to and removal from the various tip barbs associated with oxygen outlet 18 and rigid connector body 12.

FIG. 3 is an elevational plan view of the device of the present invention separated from attachment to either the supplemental oxygen supply or the nasal cannula tubing. In FIG. 3, direction reversing connector 10 is shown to comprise rigid connector body 12 with an inlet formed by oxygen outlet coupler 14 and an outlet formed by connector tip barbs 11. The linear ridges shown on oxygen outlet coupler 14 are present to increase tactile manipulation of oxygen outlet coupler 14 in connecting it to, or disconnecting it from, oxygen outlet 18 (see FIG. 2).

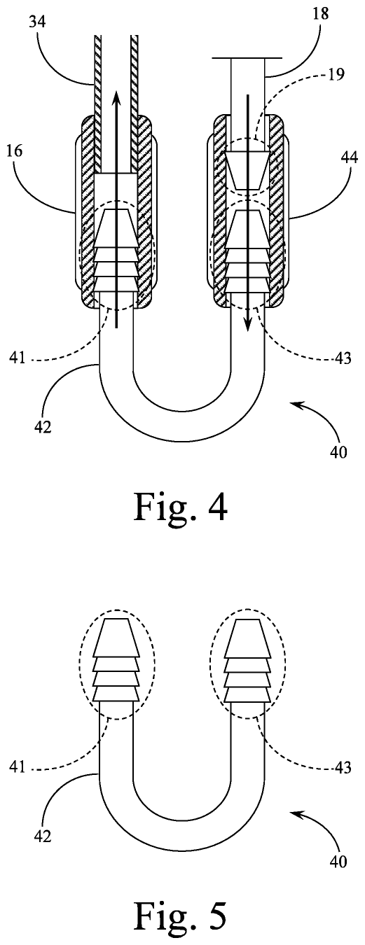

Reference is next made to FIGS. 4 & 5 for a detailed description of an alternate embodiment of the present invention. In this second embodiment, direction reversing connector 40 is shown in the partial cross-sectional view of FIG. 4 to be constructed of rigid connector body 42 with an inlet removably connectable to oxygen outlet coupler 44 and an outlet removably connectable to nasal cannula tubing coupler 16. In this somewhat more basic manner of manufacturing direction reversing connector 40, the entire connector is made of rigid or semi-rigid polymer plastic material. Rigid connector body 42 has connector inlet tip barbs 43 on the inlet end of the U-shaped connector, and connector outlet tip barbs 41 at the outlet of the connector. Connector 40 attaches to oxygen outlet 18 by way of oxygen outlet coupler 44 which is independent from (i.e. not permanently attached to) rigid connector body 42. The structures of this alternate embodiment at the outlet end of the connector are essentially the same as the outlet end of the structures of the device shown in FIG. 2. This is due to the fact that the standard nasal cannula tubing 34 typically comes with a permanently attached nasal cannula tubing coupler 16.

One advantage of the embodiment shown in FIGS. 4 & 5 is a slightly improved pivotability (swiveling) due to the three non-permanent coupling attachment points between oxygen outlet 18 and nasal cannula tubing 34. Although the press fit couplers 44 & 16 provide secure and leak free airflow, the lack of permanent adhesive attachment allows for each of the couplings to pivot or swivel to a degree with the motion of the user translated through the nasal cannula tubing 34. FIG. 5 is an elevational side view of this alternate preferred embodiment of the present invention showing direction reversing connector 40 constructed more basically from rigid connector body 42 with connector inlet tip barbs 43 and connector outlet tip barbs 41. Once again, the materials from which connector 40, and more specifically rigid connector body 42, might be constructed range from a metal U-shaped tubing section to a clear plastic tubing section shaped as shown and formed with inlet and outlet barbs for securing the more flexible couplers (preferably made of a silicone rubber material or the like) as shown in FIG. 4.

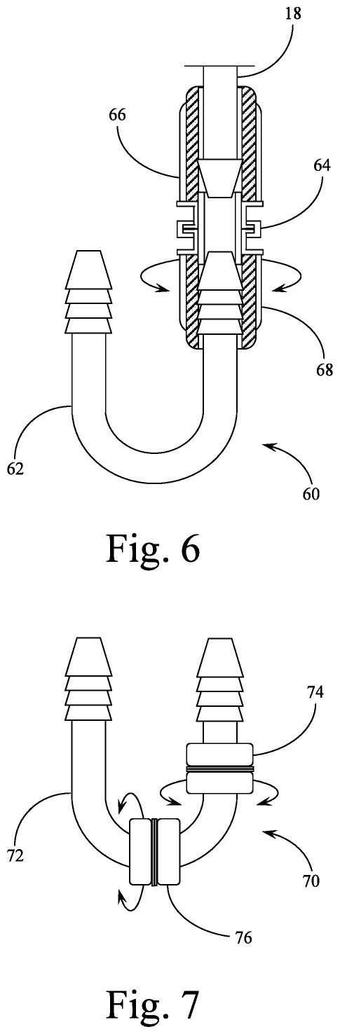

Reference is next made to FIG. 6 for a further alternate embodiment of the present invention with a unique connector coupling positioned between the device of the invention and the standard oxygen outlet. In FIG. 6, direction reversing connector 60 is shown to be constructed of rigid connector body 62 in a manner identical to the connector body 42 shown in FIG. 4. In this case however attachment of direction reversing connector 60 utilizes a swivel coupling 64 positioned between two flexible connector couplings 66 & 68. Rigid connector body 62 is secured into connector coupling 68 and oxygen outlet 18 is secured into oxygen outlet coupling 66. Structured between and integrated into flexible couplings 66 & 68 is swivel coupling 64. Although air flow through this coupling assembly is uninterrupted between oxygen outlet 18 and rigid connector body 62, mechanically the swivel coupling 64 allows for even greater ease of pivoting movement as the user might move about with the nasal cannula device (not shown in FIG. 6) attached.

Reference is finally made to FIG. 7 for a further alternate embodiment of the present invention that adds further flexibility and durability to the connector with active motion by the user in a number of different directions. In FIG. 7, direction reversing connector 70 is shown to be constructed with generally the same U-shaped rigid connector body 72 except that the tubular body is interrupted with two orthogonally oriented swivel joints. Vertical swivel joint 76 rotates in the manner shown in FIG. 7 such that the nasal cannula tubing (not shown) may drop down below the level of the oxygen supply system. At the same time, horizontal swivel joint 74 permits the same type of motion as is permitted by swivel coupling 64 shown in FIG. 6. Further alternate embodiments may eliminate one or the other of the swivel joints in U-shaped rigid connector body 72.

As indicated above, the construction of the basic U-shaped connector of the present invention as shown in FIGS. 4 & 5, combines with the inherent flexibility of the nasal cannula tubing and the various couplings used to attach the tubing to the supplemental oxygen supply, to permit a wide range of motion without the resulting bending or kinking of the nasal cannula tubing, thereby maintaining an unrestricted airflow. The various alternate embodiments of the present invention simply provide additional swivel mechanisms to improve the flexibility of motion associated with the connection when the user moves about with the nasal cannula in place.

Although the present invention has been described in terms of the foregoing preferred embodiments, this description has been provided by way of explanation only and is not intended to be construed as a limitation of the invention. Those skilled in the art will recognize modifications of the present invention that might accommodate specific medical and home health supplemental oxygen supply systems. Those skilled in the art will further recognize additional methods for modifying the material construction of the various components of the device of the present invention to accommodate reduced manufacturing costs and disposability and/or recyclability of the device after use. Such modifications, as to structure, orientation, geometry, and even material construction techniques, where such modifications are coincidental to the type of supplemental oxygen supply system used, do not necessarily depart from the spirit and scope of the invention.

I claim:

1. An ergonomic connector for positioning and orienting a length of flexible tubing between a gas supply source and a gas use device, the gas supply source having an output port oriented in an output direction and the gas use device having an input port positioned in a location generally opposite from the output direction, the ergonomic connector comprising:
a “U” shaped section of rigid tubing, the rigid tubing section having an inlet and an outlet;
an inlet coupling positioned on, and establishing a flow connection between, the gas supply source and the inlet of the rigid tubing section; and
an outlet coupling positioned on, and establishing a flow connection between, the outlet of the rigid tubing section and the length of flexible tubing;
wherein the rigid tubing section provides redirection of the orientation of the output port so as to prevent the binding or kinking of the length of flexible tubing.

2. The connector of claim 1 wherein the “U” shaped section of rigid tubing comprises molded polymer plastic material.

3. The connector of claim 1 wherein the inlet coupling comprises a section of pliable polymer tubular material.

4. The connector of claim 1 wherein the inlet coupling is permanently fixed to the inlet of the “U” shaped section of rigid tubing and is removably attachable to the output port of the gas supply source.

5. The connector of claim 1 wherein the outlet coupling is permanently fixed to the length of flexible tubing and is removably attachable to the outlet of the “U” shaped section of rigid tubing.

6. The connector of claim 1 wherein at least one of the inlet and outlet of the “U” shaped section of rigid tubing comprises at least one barb ridge to facilitate securing the appropriate coupling thereto.

7. The connector of claim 1 wherein the inlet coupling comprises an in-line swivel coupling.

8. The connector of claim 1 wherein the “U” shaped section of rigid tubing comprises at least one swivel joint interrupting a middle portion of the rigid tubing.

9. An ergonomic connector for positioning and orienting a length of flexible tubing between a supplemental oxygen supply reservoir and a nasal cannula tubing device, the oxygen supply reservoir having an output port oriented in an output direction, the output port having a flexible coupling positioned thereon, the nasal cannula tubing device having an input port positioned in a location generally opposite from the output direction, the input port having a flexible coupling positioned thereon, the ergonomic connector comprising:
a “U” shaped section of rigid tubing, the rigid tubing section having an inlet end and an outlet end, the flexible coupling of the oxygen supply reservoir output port removably connectable to the inlet end and the flexible coupling of the nasal cannula tubing device input port removably connectable to the outlet end, the inlet end and the outlet end of the “U” shaped section of rigid tubing each comprising at least one barb ridge to facilitate securing the appropriate flexible coupling thereto;
wherein the rigid tubing section provides redirection of the orientation of the output port so as to prevent the binding or kinking of the nasal cannula tubing device.

10. The connector of claim 9 wherein the “U” shaped section of rigid tubing comprises molded polymer plastic material.

11. The connector of claim 9 wherein the “U” shaped section of rigid tubing comprises at least one swivel joint interrupting a middle portion of the rigid tubing.
